(19) United States
(12) Patent Application Publication
(10) Pub. No.: US 2010/0262455 A1
(43) Pub. Date: Oct. 14, 2010

(54) Systems and methods for spreading online advertising campaigns

(75) Inventors: Niklas Karlsson, Mountain View, CA (US); Yonggang Xu, Mountain View, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Platform-A, Inc.

(21) Appl. No.: 12/385,553

(22) Filed: Apr. 10, 2009

(51) Int. Cl. G06Q 30/00

(52) U.S. Cl. 705/10; 705/26; 705/14.53

(57) ABSTRACT

A system is provided for managing the delivery of online advertisements across inventory units of an online advertising campaign. The system includes a sensor configured to detect current ad volume for an inventory unit of the online advertising campaign. The system also includes a campaign controller configured to generate a reference ad volume for the inventory unit, based on instructions and the detected ad volume; and a unit actuator configured to generate updated ad delivery control settings for the inventory unit, based on the reference ad volume and the detected ad volume. The system also includes a serving unit configured to serve an ad impression on the inventory unit based on the updated ad delivery control settings, wherein the reference ad volume is generated based on a proportion of ad volume served on the inventory unit compared to other inventory units of the online advertising campaign.

### TECHNICAL FIELD

The embodiments described below relate generally to controlling online advertising campaigns, and more specifically, to spreading advertising for an online advertising campaign across inventory units including various web sites or groups of websites.

### BACKGROUND

Internet advertisers often create online advertising campaigns that include numerous advertisements (e.g., “banner ads”) designed to be placed on websites during a specified period of time. For example, a company may design several advertisements for a product, and may wish to have the advertisements placed on websites during the sale of the product. Each time one of these advertisements is shown to a website visitor is known as an “impression.” When shown the advertisement, the user may select, or “click,” on the advertisement or may take another “action” such as completing an online form to request more information. If the user later purchases the product, the purchase is referred to as a “conversion” of the impression.

Advertisers may be interested in impressions (e.g., if they are trying to increase awareness of a brand), clicks (e.g., if they are trying to provide more information about a product), or conversions (e.g., if they are trying to make sales or get new users to sign up for services). Advertisers may pay based on, for example, impressions, clicks, or conversions over the course of an advertising campaign. An advertiser may have a spending plan that specifies how the advertiser wishes to spend its budget during a campaign. For example, the advertiser may wish to spend money only on certain days during the campaign, or may wish to spend evenly over every day of the campaign. Each advertiser may have a daily budget (e.g., $1,000 per day) and/or a daily goal of impression volume (e.g., 1000 impressions per day), known as “daily delivery” or “pacing.” Each advertiser may also desire an ad campaign to perform certain types of consumer targeting and/or achieve a particular distribution of advertisements across various websites (“spreading”).

As a result, various techniques are used to manage online ad delivery within and among advertising campaigns. In certain advertising networks, ad servers receive impression requests from publishers (e.g., websites or other entities with an inventory of online ad space). The ad servers may group ad requests from various advertising campaigns, e.g., according to impressions to be “targeted” based on a combination of attributes defined by the ad requests. In addition to targeting requirements, each ad request received from an advertiser generally includes a “bid price” and possibly a “bid allocation”. The bid price is the amount of money offered by the ad request for placement of the targeted impression. The bid allocation, if present, is the ratio (e.g., point value from 0 to 1) of targeted inventory the ad campaign is willing to purchase at the bid price. The list of ads that target a certain impression request may be sorted in descending order according to their bid price, and then placed in groups such that the sum of their bid allocations equals 1. If the ad request with the highest bid price has a bid allocation of 1, or if the bid allocation does not exist, it will always win the impression. Such ad delivery methods ensure that the advertiser with an ad with the greatest expected value is able to purchase as much inventory as desired. These methods also reveal both the marginal value of the impression inventory (e.g., the cost required per impression), and the amount of volume (e.g., the number of impressions) purchased at each price.

This type of competitive bidding marketplace may become problematic, however, when a particular “inventory unit” (i.e., a website or collection of websites) begins to award more impressions, clicks, or events than desired by the advertiser. For instance, a single website may begin awarding a substantial proportion of the campaign's impressions, resulting in insufficient diversity of unique impressions across websites. In other words, if one or more websites receive too large of a proportion of impressions, clicks, or events, the campaign may not target the variety of consumers and websites desired by the advertiser. The distribution of ad delivery may be suboptimal across any type of “inventory unit,” including individual URLs, entire domains, or certain groups of websites. Thus, the advertiser may wish to increasingly spread ad delivery across inventory units, based on impressions, clicks, conversions, or any other events measured at the inventory unit.

The present disclosure is directed to improving the control of advertising on web sites by solving one or more of the above-mentioned challenges.

### SUMMARY

In accordance with one disclosed exemplary embodiment, a system is provided for managing the delivery of online advertisements across inventory units of an online advertising campaign. The system includes a memory device configured to store instructions for managing ad delivery; and a sensor configured to detect current ad volume for an inventory unit of the online advertising campaign. The system also includes a campaign controller configured to generate a reference ad volume for the inventory unit, based on instructions and the detected ad volume; and a unit actuator configured to generate updated ad delivery control settings for the inventory unit, based on the reference ad volume and the detected ad volume. The system also includes a serving unit configured to serve an ad impression on the inventory unit based on the updated ad delivery control settings, wherein the reference ad volume is generated based on a proportion of ad volume served on the inventory unit compared to other inventory units of the online advertising campaign.

In accordance with another disclosed exemplary embodiment, a computer-implemented method is provided for managing the delivery of online advertisements across inventory units of an advertising campaign. The method includes the steps of storing instructions for controlling ad delivery; detecting current ad volume for an inventory unit of the online advertising campaign; and generating a reference ad volume for the inventory unit, based on instructions and the detected ad volume. The method also includes generating updated ad delivery control settings for the inventory unit, based on the reference ad volume and the detected ad volume; and serving an ad impression on the inventory unit based on the updated ad delivery control settings; wherein the reference ad volume is generated based on a proportion of ad volume served on the inventory unit compared to other inventory units of the online advertising campaign.

In accordance with another disclosed exemplary embodiment, a computer-readable storage medium is provided for storing a computer program which, when executed by a computer, causes the computer to perform a method of managing the delivery of online advertisements across inventory units of an advertising campaign. The method includes storing instructions for controlling ad delivery; detecting current ad volume for an inventory unit of the online advertising campaign; and generating a reference ad volume for the inventory unit, based on instructions and the detected ad volume. The method also includes generating updated ad delivery control settings for the inventory unit, based on the reference ad volume and the detected ad volume; and serving an ad impression on the inventory unit based on the updated ad delivery control settings; wherein the reference ad volume is generated based on a proportion of ad volume served on the inventory unit compared to other inventory units of the online advertising campaign.

### BRIEF DESCRIPTION OF THE DRAWINGS

FIG. 1 depicts a block diagram of an exemplary system on which online advertising campaigns may be managed, consistent with embodiments of the present disclosure;

FIG. 2 illustrates an exemplary system for managing online advertising campaigns in an advertising network, consistent with embodiments of the present disclosure;

FIG. 3 illustrates a flow diagram of an exemplary method for managing online advertising campaigns, consistent with embodiments of the present disclosure;

FIG. 4 depicts a block diagram of an exemplary system for managing online advertising campaigns, consistent with embodiments of the present disclosure;

FIG. 5a illustrates an exemplary embodiment of a unit actuator for adjusting a bid allocation, consistent with embodiments of the present disclosure;

FIG. 5b illustrates an exemplary embodiment of a unit actuator for adjusting a bid price, consistent with embodiments of the present disclosure;

FIG. 6 illustrates an exemplary embodiment of a unit actuator for managing online advertising campaigns, consistent with embodiments of the present disclosure; and

FIGS. 7a and 7b depict graphical representations of exemplary effects on website distribution from using systems and methods consistent with embodiments of the present disclosure.

### DETAILED DESCRIPTION OF THE DRAWINGS

Reference will now be made in detail to exemplary embodiments of the invention, examples of which are illustrated in the accompanying drawings. Wherever possible, the same reference numbers will be used throughout the drawings to refer to the same or like parts.

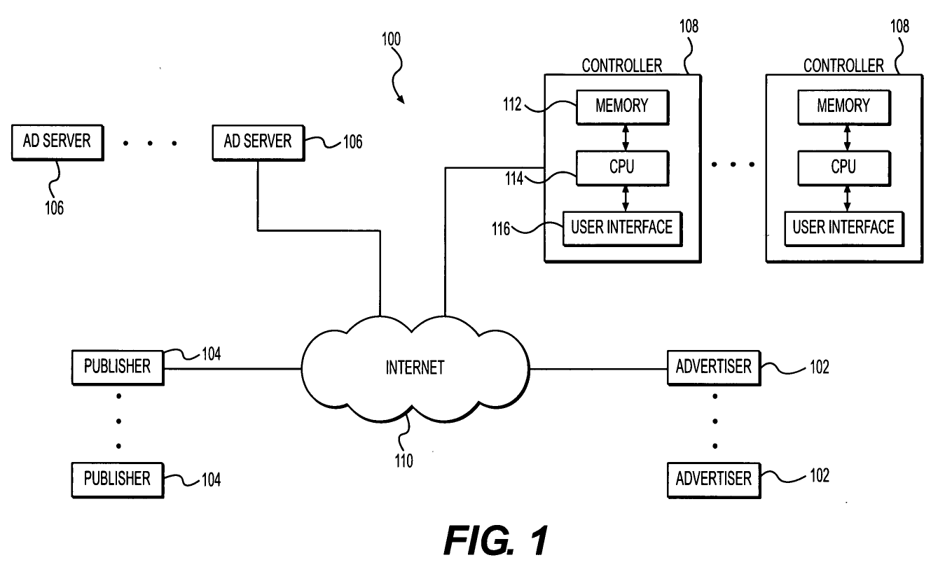

FIG. 1 illustrates an exemplary system 100 for controlling online advertising campaigns. System 100 may include a plurality of advertisers 102, publishers 104, ad servers 106, and controllers 108, in communication with the Internet 110. Advertisers 102 may include any entities having online advertisements (e.g., banner ads, pop-ups, etc.) desired to be delivered to online users. Advertisers 102 may interact with publishers 104, ad servers 106, and/or controllers 108 through computers connected to the Internet 110. Thus, advertisers 102 may be able to communicate advertising information, such as ad information, targeting information, consumer information, budget information, bidding information, etc., to other entities in system 100.

Publishers 104 may include any entities having inventories of available online advertising space. For example, publishers 104 may include online content providers, search engines, e-mail programs, or any entity or program having online user traffic. Publishers 104 may interact with advertisers 102, ad servers 106, and/or controllers 108 via computers connected to the Internet 110. Thus, publishers 104 may be able to communicate inventory information, such as site information, demographic information, cost information, etc., to other entities in system 100.

Ad servers 106 may include any type of servers configured to process advertising information from advertisers 102 and/or inventory information from publishers 104, either directly or indirectly. In certain embodiments, ad servers 106 may be remote web servers that receive advertising information from advertisers 102 and serve ads to be placed by publishers 104. Ad servers 106 may be configured to serve ads across various domains of publishers 104, for example, based on advertising information provided by advertisers 102. Ad servers 106 may also be configured to serve ads based on contextual targeting of web sites, search results, and/or user profile information. In some embodiments, ad servers 106 may be configured to serve ads based on control signals generated by controllers 108.

Controllers 108 may include one or more computing systems configured to receive information from entities in system 100, process the information, and generate control signals to be sent to entities in system 100, according to methods described herein. Controllers 108 may include any type or combination of computing systems, such as clustered computing machines and/or servers. In one embodiment, each controller 108 may be an assembly of hardware, including a memory 112, a central processing unit (“CPU”) 114, and/or a user interface 116. Memory 112 may include any type of RAM or ROM embodied in a physical storage medium, such as magnetic storage including floppy disk, hard disk, or magnetic tape; semiconductor storage such as solid state disk (SSD) or flash memory; optical disc storage; or magneto-optical disc storage. CPU 114 may include one or more processors for processing data according to instructions stored in the memory. The functions of the processor may be provided by a single dedicated processor or by a plurality of processors. Moreover, the processor may include, without limitation, digital signal processor (DSP) hardware, or any other hardware capable of executing software. User interface 116 may include any type or combination of input/output devices, such as a display monitor, keyboard, and/or mouse.

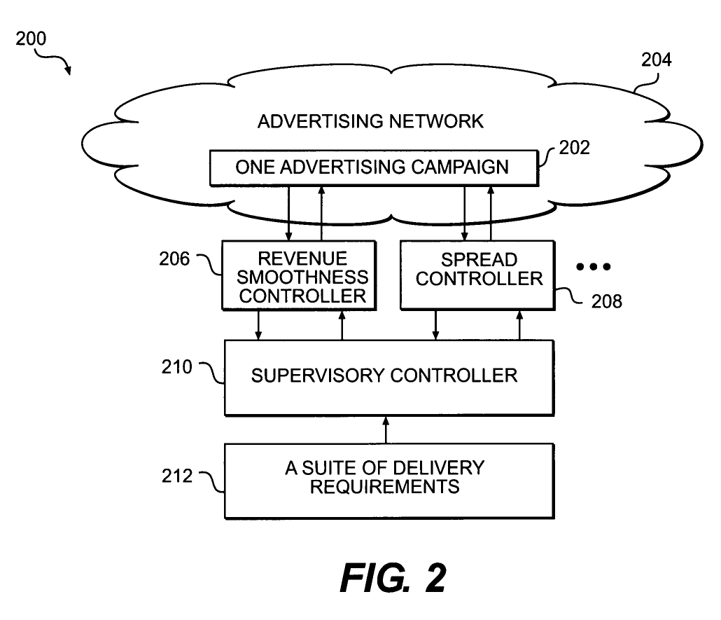

FIG. 2 illustrates an exemplary control system 200 for controlling an advertising campaign 202 operating in an online advertising network 204 of system 100. Of course, any number or type of advertising campaigns 202 may be operated within advertising network 204, across various ad servers and domains associated with the Internet.

Control system 200 may be implemented by one or more of the advertisers 102, publishers 104, ad servers 106, and/or controllers 108 described in FIG. 1. In one embodiment, control system 200 may include, among other control modules, a revenue smoothness controller 206 and a spread controller 208, both of which may be at least partially managed by a supervisory controller 210. Revenue smoothness controller 206, spread controller 208, and supervisory controller 210 may be computers connected to the Internet, as described with respect to ad servers 106 and controllers 108 of system 100. Alternatively, revenue smoothness controller 206, spread controller 208, and supervisory controller 210 may be software modules executed by CPUs 114 of controllers 108 and/or ad servers 106. Revenue smoothness controller 206, spread controller 208, and supervisory controller 210 may be embodied entirely in hardware, entirely in software, or in a combination of hardware and software.

Supervisory controller 210 may be provided with a suite of delivery requirements 212, which may be adjustable design parameters set by a user. For instance, delivery requirements may include daily budget goals, daily impression delivery goals, targeting instructions, and/or spread constraints for controlling advertising across inventory units, etc. The suite of delivery requirements 212 may be implemented by one or more controllers of system 200, including revenue smoothness controller 206, spread controller 208, and supervisory controller 210.

In one embodiment, revenue smoothness controller 206 may be a controller configured to assist an advertising campaign 202 in meeting daily budget and impression goals. For example, in one embodiment, revenue smoothness controller 206 may implement the systems and methods described in U.S. patent application Ser. No. 11/907,587, filed on Oct. 15, 2007, the entire disclosure of which is incorporated herein by reference. Spread controller 208 may be another controller configured to operate in cooperation with revenue smoothness controller 206, for the purpose of spreading ad delivery across various inventory units of an ad campaign 202, consistent with systems and methods described herein.

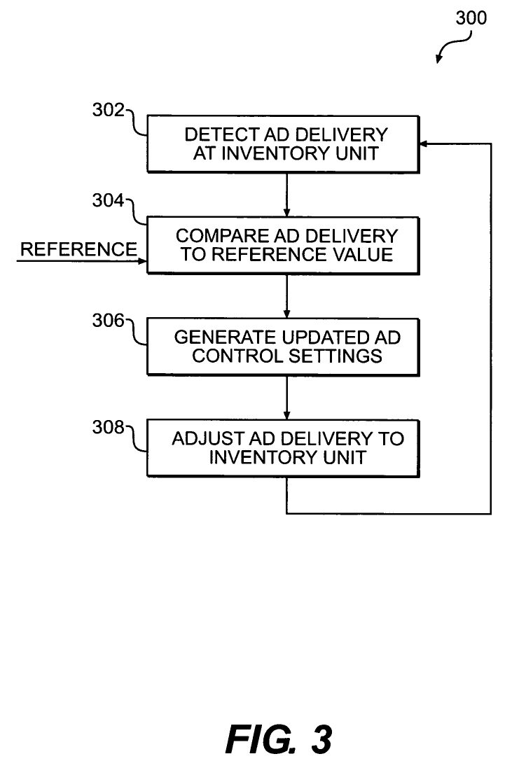

FIG. 3 depicts a flow diagram illustrating an exemplary control method 300 for using spread controller 208 to spread ad delivery across various inventory units of an ad campaign. As will be described in more detail below, control method 300 may include one or more steps for adjusting the distribution of ad delivery as measured by impressions, clicks, conversions, or any other events occurring for each inventory unit of an ad campaign. In general, control method 300 may begin by detecting ad delivery at an inventory unit (step 302). For example, the method may involve determining how many impressions, clicks, or events are associated with a particular website in a particular period of time. Control method 300 may then compare ad delivery at that inventory unit to a reference value received for that inventory unit (step 304). The reference value may be a particular quantity of ad impressions, clicks, or events that have been calculated by spread controller 208 and/or supervisory controller 210. The method may further involve generating updated ad control settings for the inventory unit based on the comparison to the reference value (step 306). The updated ad control settings may include an updated bid price control signal and/or an updated bid allocation control signal. For example, if delivery to the particular inventory unit is higher than the reference value, then the bid price and/or bid allocation values may be reduced accordingly to limit the competitiveness of the ad campaign relative to the inventory unit. The method may further include adjusting ad delivery to the inventory unit by implementing the generated updated ad control settings (step 308). For example, the updated bid price control signal and/or bid allocation control signal may be sent to an actuator associated with the inventory unit. The method may continue to operate in a closed-loop, by again detecting ad delivery at the inventory unit (step 302).

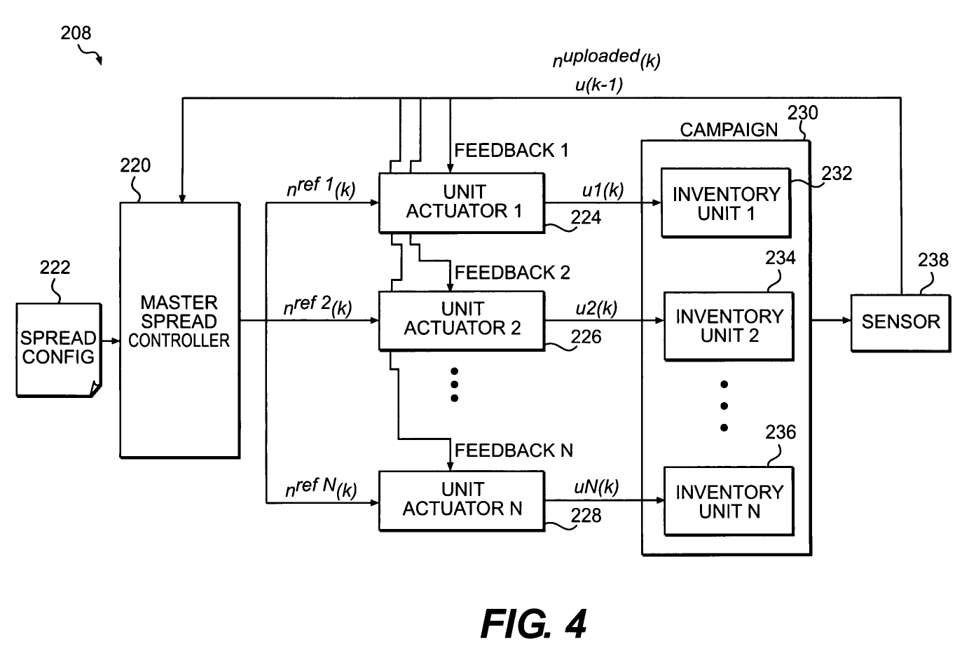

FIG. 4 depicts an exemplary embodiment of spread controller 208. As shown in FIG. 4, spread controller 208 may include a master spread controller 220, a plurality of unit actuators 224-228, and a sensor 238. Each spread controller 208 may be associated with a particular ad campaign 230, for which ads are served on a plurality of inventory units 232-236. In general, campaign 230 may represent the system (or “plant” as it is referred to in control theory), for which ad delivery may be controlled by spread controller 208.

Master spread controller 220 of spread controller 208 may be provided with a spread configuration 222. For example, as described above with respect to the suite of delivery requirements 212 associated with supervisory controller 210, spread configuration 222 may be a user-defined input, which may include maximum and minimum delivery ratios, daily budgets, targeting information, event requirements, etc. For example, in one embodiment, spread configuration 222 may include instructions for no inventory unit to receive more than a certain proportion (e.g., 10% or 15%) of a campaign's available impressions. As described above, each inventory unit may be a single URL, an entire domain, or any desired groups of websites. Thus, the user may selectively limit delivery across inventory units of websites or groups of websites, as desired. Master spread controller 220 may be configured to receive feedback from sensor 238 and generate reference signals n^{ref}(k) designed for particular unit actuators 224-228, based on the spread configuration 222 and the feedback from sensor 238.

Master spread controller 220 may be disposed in communication with a plurality of unit actuators 224-228. Unit actuators 224-228 may be individualized controllers configured to generate updated ad control signals, u(k), designed for respective inventory units 232-236 of campaign 230. For example, as shown in FIG. 4, unit actuator 224 may generate a control signal u1(k) for inventory unit 232 of campaign 230, unit actuator 226 may generate a control signal u2(k) for inventory unit 234 of campaign 230, and so on. Each control signal u(k) may include ad delivery instructions, such as a bid price value and/or bid allocation value tailored for each respective inventory unit 232-236 of campaign 230.

Master spread controller 220 may also be disposed in communication with sensor 238, which is disposed in communication with, and configured to detect conditions of, inventory units of campaign 230. Sensor 238 may be configured to obtain real-time data about one or more inventory units on which ads are delivered for campaign 230. For example, sensor 238 may measure operating conditions of campaign 230, such as impression, click, event, and/or action volumes for each inventory unit 232-236. In one embodiment sensor 238 may output a marginal impression volume n(k), a reference impression volume n^{ref}(k), a preceding control signal u(k-1), and/or an uploaded impression volume n^{uploaded}(k), for each time k of a campaign. Sensor 238 may be configured to feed such data to master spread controller 220, and one or more of the unit actuators 224-228.

Unit actuators 224-228 may be configured to receive reference signals from master spread controller 220 and feedback signals from sensor 238. Unit actuators may further be configured to generate control signals, u(k), based on those inputs for each time k of a campaign. For example, unit actuators 224-228 may be configured to modify ad delivery settings (e.g., bid price and/or bid allocation) for particular inventory units of campaign 230, by sending updated ad delivery control signals u(k). In general, each unit actuator 224-228 may compare reference volumes n^{ref}(k) received from master spread controller 220 with feedback signals n^{uploaded}(k) received from sensor 238, to determine how to adjust ad delivery control settings.

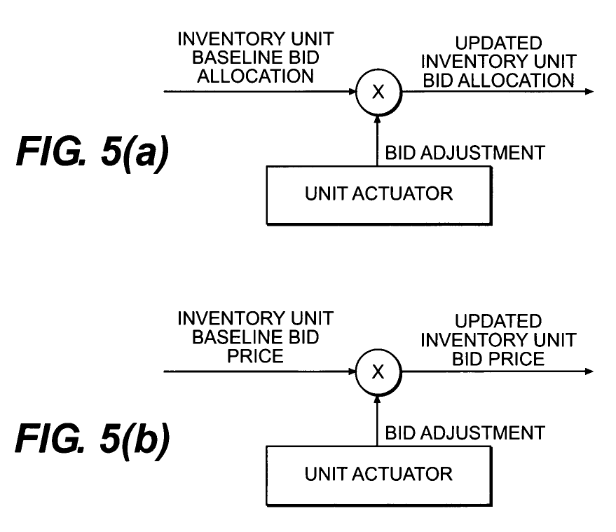

FIGS. 5a and 5b illustrate exemplary embodiments for how unit actuators 224-226 may modify control signals sent to particular inventory units of an ad campaign. Specifically, FIG. 5a illustrates a unit actuator applying a multiplicative bid adjustment to a baseline bid allocation for an inventory unit, in order to generate an updated inventory unit bid allocation. For example, if delivery at an inventory unit is too high, the unit actuator may reduce the bid allocation value from 1.0 to 0.8 by multiplying the bid allocation value by 0.8. Thus, the unit actuator may reduce the ad delivery to a particular inventory unit by selectively reducing the bid allocation for that inventory unit. In addition to adjusting the bid allocation value, each unit actuator may also, or alternatively, adjust the bid price value for the inventory unit. FIG. 5b illustrates a unit actuator applying a multiplicative bid adjustment to a baseline bid price for an inventory unit, in order to generate an updated inventory unit bid price. For example, if delivery at an inventory unit is too high, the unit actuator may reduce the bid price value from $0.50 per impression to $0.40 by multiplying the bid price value by 0.8. Thus, the unit actuator may reduce the ad delivery to a particular inventory unit by selectively reducing the competitiveness of the bid price for that inventory unit. The ad delivery to a particular inventory unit of a campaign may be selectively reduced by any desired combination or ratio of reductions in the bid price and bid allocations. Of course, the unit actuators may increase or decrease the bid allocation and/or bid price by any other suitable mathematical operation, such as addition, or the application of any suitable function. As will be described in more detail below, in one embodiment, the multiplicative adjustments to the bid price and/or bid allocation may begin using the numeral 1, such that no adjustment is initially performed.

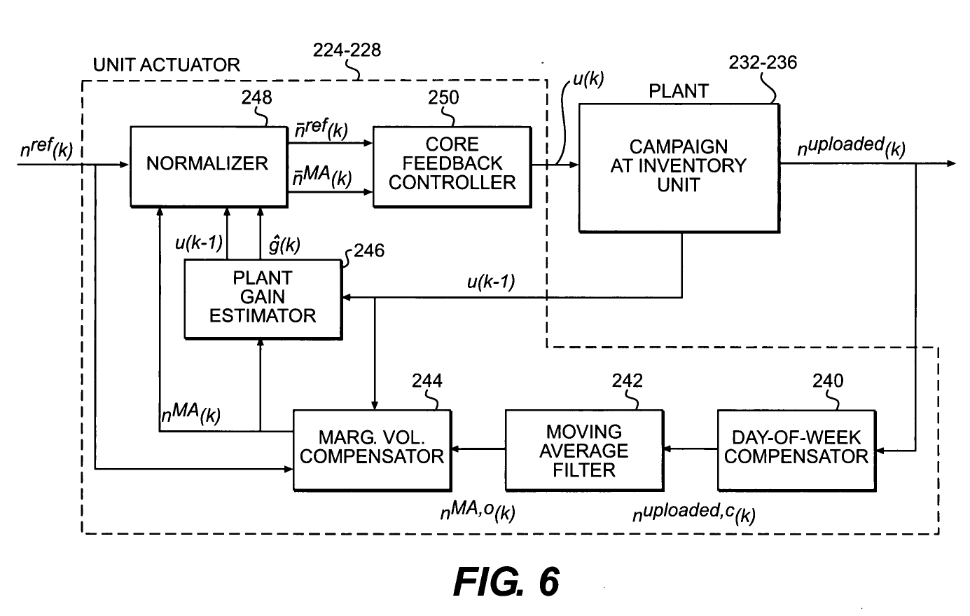

FIG. 6 illustrates one exemplary embodiment for one of the unit actuators 224-228 associated with an inventory unit 232-236 (i.e., “plant”). In general, for each time k of a campaign, a unit actuator may receive an advertising event volume, n^{uploaded}(k), of the inventory unit (i.e., “feedback”), and a reference volume signal, n^{ref}(k), from the master spread controller 220. The advertising event volume, n^{uploaded}(k), may be a number of impressions, clicks, conversions, or any other advertising event, as detected by a sensor at the inventory unit. The reference volume signal, n^{ref}(k), may be a desired number of advertising events (e.g., impressions, clicks, conversions, etc.), as generated by master spread controller 220. Using the advertising event volume, n^{uploaded}(k), and reference volume signal, n^{ref}(k), the unit actuator may be configured to generate a control signal u(k) to be applied to an inventory unit 232-236 of a campaign. As described above with respect to FIG. 4, the systems and methods herein may include a plurality of unit actuators, each being configured to generate a control signal u(k) for a particular inventory unit of an ad campaign.

In one embodiment, each unit actuator 224-228 may be a unit controller having a plurality of different modules, which, together, may be configured to calculate a control signal u(k) based on the two input signals, n^{uploaded}(k), n^{ref}(k), and historical data of the modules and the inventory unit. For example, in one embodiment, each unit actuator may include a day-of-week compensator 240, a moving average filter 242, a marginal volume compensator 244, a plant gain estimator 246, a normalizer 248, and a core feedback controller 250.

Day-of-week compensator 240 may be configured to account for the fact that website traffic is generally lighter (i.e., less volume) for most websites on the weekends, as opposed to weekdays. Day-of-week compensator 240 may be configured to allow advertising event volume to follow its natural day-of-week pattern, such that a website's control signal, u(k), remains relatively constant throughout the week. In one embodiment, day-of-week compensator 240 may achieve this goal by compensating the uploaded advertising event volume, n^{uploaded}(k), based on a ratio between the average weekday volume and the average weekend volume, which may be denoted as, p^{weekday2weekend}

Thus, in one embodiment, the input to day-of-week compensator 240 may be the marginal uploaded event volume n^{uploaded}(k), where k is a timestamp of the campaign, and the output may be a compensated value of the marginal uploaded event volume n^{uploaded,c}(k), which has been computed as follows:

$${n}^{uploaded , c} ( k ) = \{ \begin{matrix}\frac{{h}^{weekdays} {p}^{weekday 2 weekend} + ( 168 - {h}^{weekdays} )}{168 {p}^{weekday 2 weekend}} {n}^{uploaded} ( k ) , & if in weekdays \\ \frac{{h}^{weekdays} {p}^{weekday 2 weekend} + ( 168 - {h}^{weekdays} )}{168} {n}^{uploaded} ( k ) , & otherwise\end{matrix}$$

where h^{weekdays} represents the number of weekday hours in one week, (e.g., 120 hours=5 weekdays*24 hours/day), and 168 represents the number of hours in one week. The ratio of p^{weekday2weekend} may be selected by a user based on any known experimental data, based on, for example, the corresponding ratio of the whole network or a ratio specific to a campaign at an inventory unit. Thus, day-of-week compensator 240 may generate a compensated value of the marginal uploaded volume n^{uploaded,c}(k).

Moving average filter 242 may receive the compensated value of the marginal uploaded volume, n^{uploaded,c}(k), from day-of-week compensator 240. Similar to day-of-week compensator 240, moving average filter 242 may be configured to average out a time-of-day pattern inherent in the network. Moving average filter 242 may also be configured to reduce any noise in the volume signal. For this purpose, moving average filter 242 may incorporate any desired time interval, such as an interval of 24 hours (i.e., a “lookback window”). During a particular 24 hour lookback window, moving average filter 242 may generate a value, n^{MA,o}(k), which may represent the 24-hour moving sum of n^{uploaded,c}(k) for a given lookback window. Of course, n^{MA,o} may represent the moving sum of n^{uploaded,c}(k) for any predetermined time interval. In an embodiment in which lookback window is 24 hours, moving average filter 242 may be implemented as follows:

$${n}^{MA , o} ( k ) = {\sum }_{l = 0}^{l = 24 {f}^{sampling} - 1} {n}^{uploaded , c} ( k - l )$$

where f^{sampling} is the sampling frequency in cycles/hour, and n^{MA,o} [symbol] is initialized by setting it equal to

$$\frac{{n}^{ref} ( 0 )}{24 {f}^{sampling}}$$

for any [symbol] ≦0.

Marginal volume compensator 244 may be configured to compensate for the marginal uploaded value of the moving sum, n^{MA,o}(k), in the event that a campaign is paused for external reasons. For example, if a campaign is paused due to daily budgetary or delivery constraints imposed by another controller, the marginal uploaded volume, n^{uploaded}(k), and therefore the compensated marginal uploaded volume, n^{uploaded,c}(k), may both reduce to zero. In such circumstances, unless compensation is performed, the controller may operate in an open-loop mode in which control signal, u(k), is aggressively increased out of a desire to increase event volume. In order to compensate for such low volume events, marginal volume compensator 244 may be configured to receive the marginal uploaded value of the moving sum, n^{MA,o}(k), from moving average filter 242.

Marginal volume compensator 244 may also receive a volume reference n^{ref}(k) from master spread controller 220, a marginal uploaded volume, n^{uploaded,c}(k), compensated by day-of-week compensator 240, and a binary signal, u^{HSC}(k), which indicates whether the campaign is active. Marginal volume compensator 244 may be configured to generate a volume output denoted, n^{MA}(k), as calculated below:

$${n}^{MA} ( k ) = \{ \begin{matrix}{n}^{MA , o} ( k ) + {α}^{MVC} \frac{{n}^{ref} ( k )}{24 {f}^{sampling}} , & if {u}^{HSC} ( k ) = 1 \\ {n}^{MA , o} ( k ) , & otherwise\end{matrix}$$

where α^{MVC} is a design parameter, defaulted to be 1.

Thus, marginal volume compensator 244 may be configured to modify the marginal uploaded volume (i.e., increase it by a multiple of the reference value n^{ref}(k)), in the event that the campaign is not active and u^{HSC}(k) is set to 1. Otherwise, if the campaign is active and u^{HSC}(k) is set to 0, then marginal uploaded volume n^{MA,0}(k) may be unaltered by marginal volume compensator 244.

Plant gain estimator 246 may be configured to calculate the estimated plant gain, ĝ(k), based on the compensated moving average of the marginal uploaded volume, n^{MA}(k), and the control signal generated in the previous sampling period, u(k-1). Thus, plant gain estimator 246 may receive the compensated moving average of the marginal uploaded volume, n^{MA}(k), from the marginal volume compensator 244. In one embodiment, plant gain estimator 246 may define the gain, ĝ(k), as follows:

$$\hat{g} ( k ) = {λ}^{gain} \hat{g} ( k - 1 ) + ( 1 - {λ}^{gain} ) \frac{{n}^{MA} ( k )}{u ( k - 1 )}$$

where λ^{gain} is a design parameter, defaulted to be 0.05. The plant gain estimator 246 may be initialized, as follows:

$$\hat{g} ( 0 ) = \frac{{n}^{ref} ( 0 )}{24 {f}^{sampling} u ( 0 )}$$

where n^{ref}(0) is the initial daily reference, u(0) is the initial control signal, and f^{sampling} is the sampling frequency (cycles/hour). Thus, plant gain estimator 246 may generate a gain signal, ĝ(k), which is a function of the control signal of the previous sampling period, u(k-1), and the compensated moving average of the marginal uploaded volume, n^{MA}(k).

Normalizer 248 may receive the gain signal, ĝ(k), from plant gain estimator 246, the daily volume reference n^{ref}(k) from the master spread controller 220, and the compensated moving average of the marginal uploaded volume, n^{MA}(k). The normalizer 248 may calculate a normalized reference n̅^{ref}(k) and a normalized feedback signal n̅^{MA}(k) based on the daily volume reference n^{ref}(k), the compensated moving-average of the marginal uploaded volume n^{MA}(k), the estimated plant gain ĝ(k), and the control signal generated in the previous sampling period u(k-1). In one embodiment, normalizer 248 may calculate the normalized feedback signal n̅^{MA}(k) as follows:

$${\overline{n}}^{MA} ( k ) = \{ \begin{matrix}{λ}^{normlizer} {\overline{n}}^{MA} ( k - 1 ) + ( 1 - {λ}^{normalizer} ) u ( k - 1 ) , & if \hat{g} ( k ) = 0 \\ {λ}^{normalizer} {\overline{n}}^{MA} ( k - 1 ) + ( 1 - {λ}^{normalizer} ) \frac{{n}^{MA} ( k )}{\hat{g} ( k )} , & otherwise\end{matrix}$$

where λ^{normalizer} is a design parameter with a default values 0.975. In one embodiment, normalizer 248 may calculate the normalized reference n̅^{ref}(k) as follows:

$${\overline{n}}^{ref} ( k ) = {λ}^{normalizer} {\overline{n}}^{ref} ( k - 1 ) + ( 1 - {λ}^{normalizer} ) min \{ \frac{{n}^{ref , flt} ( k )}{\hat{g} ( k )} , {α}^{ref 2 feedback} {\overline{n}}^{MA} ( k ) \}$$

where α^{ref2feedback} is a design parameter with default value 1, and

$${n}^{ref , flt} ( k ) = {λ}^{ref} {n}^{ref , flt} ( k - 1 ) + ( 1 - {λ}^{ref} ) \frac{{n}^{ref} ( k )}{24 {f}^{sampling}}$$

where λ^{ref} is a design parameter with default value 0.975. Normalizer 248 may be initialized with the following values of n̅^{MA}(k) and n̅^{ref}(k):

$${\overline{n}}^{MA} ( 0 ) = u ( 0 )$$

$${n}^{ref , flt} ( 0 ) = \frac{{n}^{ref} ( 0 )}{24 {f}^{sampling}}$$

$${\overline{n}}^{ref} ( 0 ) = u ( 0 )$$

Thus, normalizer 248 may be configured to generate a normalized marginal reference n̅^{ref}(k) (i.e., “reference signal”) and a normalized moving average uploaded volume n̅^{MA}(k) (i.e., “feedback signal”) to be sent to core feedback controller 250 for generation of an updated ad delivery control signal, u(k).

Core feedback controller 250 may be configured to generate the updated control signal u(k) based on the normalized marginal reference n̅^{ref}(k) (i.e., “reference signal”) and the normalized moving average uploaded volume n̅^{MA}(k) (i.e., the “feedback signal”), according to the following:

u(k)=Proj{(1+r₁)u(k−1)−r₁u(k−2)−s₀ n̅^{MA}(k)+(s₀+t₀) n̅^{ref}(k)−t₀(1+r₀) n̅^{ref}(k−1)+t₀r₁ n̅^{ref}(k−2)}_{[u}_{^{min}}_{,u}_{^{max}}_{]}

where Proj{x}_{[umin;umax]} equals uₘᵢₙ if x<uₘᵢₙ, uₘₐₓ if x>uₘₐₓ, and x otherwise. The core feedback controller 250 may be initialized with the following:

u(l)=u(0)

n n̅^{ref}(l)= n̅^{ref}(0)

n̅^{MA}(l)= n̅^{MA}(0)

for all l<0, where u(0) is the initial control signal, and u(0) is set to 1.

In one embodiment, the controller coefficients may be calculated once during an initialization procedure, as follows:

a₁=−2e ^{ξω}^{₀}^{/f}^{^{sampling}} cos(\sqrt{1−ξ²ω₀/f^{sampling}})

a₂=e^{-2ξω}^{₀}^{/f}^{^{sampling}}

r₁=−1−a₁

s₀=a₂+a₁+1

The design parameters ω₀, ξ, and t₀ may be selected such that the controller is fast enough to achieve desired spread control but not so fast as to intervene with budget smoothness control, e.g., performed by revenue smoothness controller 206. In one embodiment, the default values of design parameters ω₀, ξ, and to may be set to 0.01, 1.0, and 0.3, respectively. The parameters u^{min} and u^{max} may be the lower and upper bounds of the control signal, u(k), with default values of 1 E⁻⁴ and 1, respectively.

Thus, in general, core feedback controller 250 may generate a control signal u(k), which is designed for a particular inventory unit, based on the previous control signal implemented by the inventory unit, u(k-1), the uploaded advertising event volume, n^{uploaded}(k), and the reference volume signal, n^{ref}(k). As described above, the uploaded advertising event volume, n^{uploaded}(k) implemented by core feedback controller 250 may have been compensated, normalized, and/or otherwise adjusted by one or more of the day-of-week compensator 240, moving average filter 242, marginal volume compensator 244, plant gain estimator 246, and normalizer 248, to generate a normalized moving average uploaded volume n̅^{MA}(k). The reference volume signal, n^{ref}(k), received from master spread controller 220, may have been normalized by normalizer 248, to generate a normalized marginal reference n̅^{ref}(k).

In one embodiment, the control signal, u(k), generated by core feedback controller 250 may be designed to adjust a future uploaded advertising event volume, n^{uploaded}(k), closer to the reference volume signal n^{ref}(k) (i.e., perform closed-loop feedback). As described above with respect to FIGS. 5a and 5b, control signal, u(k), may be a vector or matrix comprising a variety of control instructions, such as a bid price control signal, a bid allocation control signal, and/or any other targeting or budgetary instructions that impact future advertising event volume for the inventory unit. Thus, each unit actuator 224-228 associated with an inventory unit of an ad campaign may comprise a core feedback controller 250 configured to adjust or update the bid price and bid allocation components of a control signal u(k), to make the advertising event volume, n^{uploaded}(k), generally converge on the reference volume signal, n^{ref}(k), if possible. In some circumstances, it may be difficult or impossible for advertising event volume, n^{uploaded}(k), to completely converge on the reference volume signal, n^{ref}(k), as desired, due to strong time-of-day patterns, or for example, if the control signals have become saturated (i.e., further adjustment of the bid allocation and/or bid price can no longer affect the event volume).

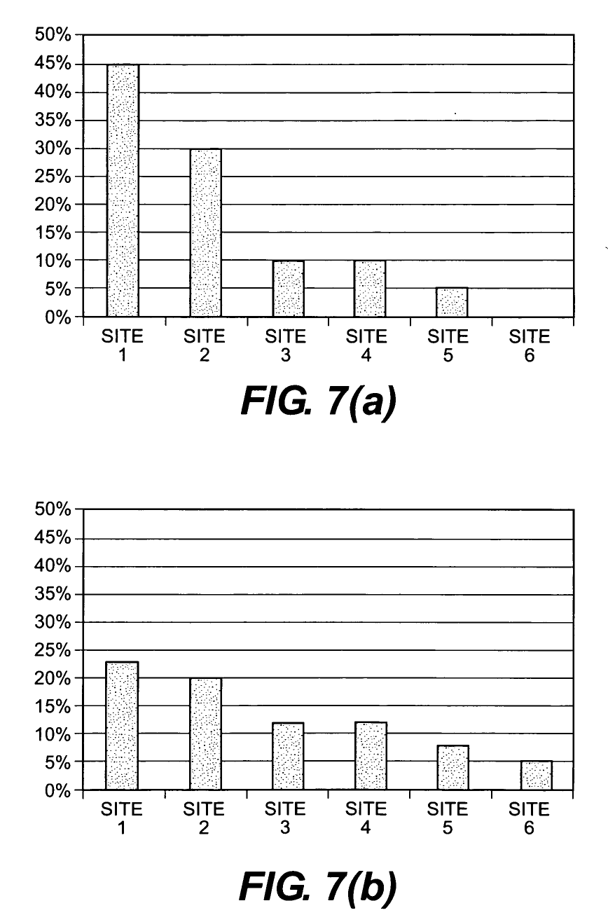

FIGS. 7a and 7b graphically depict the exemplary effects of implementing the systems and methods described herein. The presently disclosed systems and methods may involve determining whether ads are being delivered to one or more inventory units above a certain threshold level or delivery percentage (e.g., based on impressions, clicks, conversions, etc.). The system may reduce the bid prices and/or bid allocations directed to any “dominating” inventory units on which ads are being over-delivered. As a result, the system may effectively reduce the competitiveness and delivery rates associated with those inventory units.

Specifically, FIG. 7a illustrates an exemplary scenario in which an ad campaign is delivering ads across five inventory units, which in this exemplary embodiment may include 5 websites (sites 1-5), with each website contributing a certain percentage of the ad campaign's delivery. Assuming, for example, that a master spread controller 220 has been provided with a spread configuration requiring that no single inventory unit (in this case website) receive more than 25% of the campaign's ad events, master spread controller 220 may initiate a spreading method. Specifically, master spread controller 220 may generate new volume reference values, n^{ref}(k), for each inventory unit. For example, master spread controller 220 may determine that the impression volume for site 1 should be approximately 2000 impressions per time interval, instead of 4000 impressions per time interval, such that site 1 might reduce from 45% of the campaign's delivery to 23% of the campaign's delivery. Master spread controller 220 might generate a similarly lowered impression volume reference for site 2, such that its contribution to the campaign delivery drops from 30% to 20%. Master spread controller 220 may selectively reduce delivery to particular inventory units by sending lower reference volume signals n^{ref}(k) to the respective unit actuator 224-228 associated with spread controller 208. The respective unit actuator may then adjust the respective control signal, u(k), as described above with respect to FIGS. 5a, 5b, and 6. Unit actuators 224-228 may continue to adjust particular control signals, u(k), as necessary until the effective volumes delivered to inventory units have converged on the respective reference volumes defined by master spread controller 220. In addition, master spread controller 220 may continue to adjust reference volume signals, n^{ref}(k), until effective volumes delivered to inventory units are consistent with the spreading configurations defined by a user.

FIG. 7b illustrates that the proportional contribution of sites 1 and 2 may be reduced, according to the above-described systems and methods. However, in some embodiments, the method may also have the collateral effect of reducing the overall rate of ad delivery across all of the websites associated with the ad campaign. Specifically, if spread controller 208 only reduces delivery to particular inventory units over a certain threshold, the overall delivery for the campaign may be reduced. If the overall rate of ad delivery drops below the total desired rate of ad delivery for the whole campaign, a separate revenue smoothness controller 206 may be triggered to increase the bid prices across all of the web pages (including the dominating sites) in order to bring the rate of ad spending and delivery up to the campaign's desired level. Because this may cause the dominating sites to again surpass the threshold level of delivery, the spread controller 208 may again reduce the bid prices and/or bid allocations for the particular dominating sites. Accordingly, the systems and methods described herein may perform iterative adjustments to achieve a desired level of spreading of advertising across various websites via feedback mechanisms.

The advertising spreading systems and methods described herein may be advantageously decentralized in nature. Specifically, when the master spread controller 208 is applied to a campaign, one unit actuator may be applied to one inventory unit, each obtaining data related to that inventory unit and modifying delivery behavior for that unit. Unit actuators for different inventory units may be independent and may not be required to share information. Likewise, master spread controllers for different ad campaigns may be independent and may not be required to share information. As a result, these spread control systems and methods may be applicable to any number of campaigns and any number of inventory units in an efficient and scalable manner.

Although the presently disclosed systems and methods have been described with respect to spreading online advertising, these embodiments may be equally as applicable to any types of resource allocation problems in various distributed systems. For example, when an unknown and changing number of users share certain data communication bandwidth, a protocol that incorporates these spread controller methods and a similar bidding system may be used to make sure that resource is shared dynamically by at least a certain number of users, instead of being used by only a few users. The method may also be used to ensure that no single user has access to more than a certain proportion of the available bandwidth.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A system for managing the delivery of online advertisements across inventory units of an online advertising campaign, the system comprising:
a memory device configured to store instructions for managing ad delivery;
a sensor configured to detect current ad volume for an inventory unit of the online advertising campaign;
a campaign controller configured to generate a reference ad volume for the inventory unit, based on instructions and the detected ad volume;
a unit actuator configured to generate updated ad delivery control settings for the inventory unit, based on the reference ad volume and the detected ad volume; and
a serving unit configured to serve an ad impression on the inventory unit based on the updated ad delivery control settings;
wherein the reference ad volume is generated based on a proportion of ad volume served on the inventory unit compared to other inventory units of the online advertising campaign.

2. The system of claim 1, wherein the current ad volume detected by the sensor includes one of impression volume, click volume, conversion volume, and action volume.

3. The system of claim 1, wherein the reference ad volume includes one of impression volume, click volume, conversion volume, and action volume.

4. The system of claim 1, wherein the reference ad volume is further generated based on one or more of delivery ratios, daily budgets, targeting information, and event requirements.

5. The system of claim 1, wherein the ad delivery control settings include one or more of a bid allocation control signal and a bid price control signal.

6. The system of claim 1, wherein the unit actuator is configured to generate the updated ad delivery control settings by applying a mathematical operator or function to an existing set of ad delivery control settings.

7. The system of claim 6, wherein the ad delivery control settings include one or more of a bid allocation control signal and a bid price control signal, and the unit actuator adjusts one or more of the bid allocation control signal and the bid price control signal to achieve a delivery goal defined by the reference ad volume.

8. The system of claim 1, wherein the unit actuator is further configured to generate the updated ad delivery control settings for the inventory unit based on one or more of time-of-day patterns, day-of-week patterns, and marginal volume compensations.

9. The system of claim 1, wherein the unit actuator generates updated ad delivery control settings for the inventory unit independently from unit actuators for other inventory units.

10. A computer-implemented method for managing the delivery of online advertisements across inventory units of an online advertising campaign, the method comprising:
storing instructions for controlling ad delivery;
detecting current ad volume for an inventory unit of the online advertising campaign;
generating a reference ad volume for the inventory unit, based on instructions and the detected ad volume;
generating updated ad delivery control settings for the inventory unit, based on the reference ad volume and the detected ad volume; and
serving an ad impression on the inventory unit based on the updated ad delivery control settings;
wherein the reference ad volume is generated based on a proportion of ad volume served on the inventory unit compared to other inventory units of the online advertising campaign.

11. The method of claim 10, wherein the current ad volume includes one of impression volume, click volume, conversion volume, and action volume.

12. The method of claim 10, wherein the reference ad volume includes one of impression volume, click volume, conversion volume, and action volume.

13. The method of claim 10, wherein the reference ad volume is further generated based on one or more of delivery ratios, daily budgets, targeting information, and event requirements.

14. The method of claim 10, wherein the ad delivery control settings include one or more of a bid allocation control signal and a bid price control signal.

15. The method of claim 10, wherein the updated ad delivery control settings are generated by applying a mathematical operator or function to existing ad delivery control settings.

16. The method of claim 15, wherein the ad delivery control settings include one or more of a bid allocation control signal and a bid price control signal, and one or more of the bid allocation control signal and the bid price control signal are adjusted to achieve a delivery goal defined by the reference ad volume.

17. The method of claim 10, wherein the updated ad delivery control settings for the inventory unit are further generated based on one or more of time-of-day patterns, day-of-week patterns, and marginal volume compensations.

18. The method of claim 10, wherein the updated ad delivery control settings for the inventory unit are generated independently from settings for other inventory units.

19. A computer-readable storage medium storing a computer program which, when executed by a computer, causes the computer to perform a method of managing the delivery of online advertisements across inventory units of an advertising campaign, the method comprising the steps of:
storing instructions for controlling ad delivery;
detecting current ad volume for an inventory unit of the online advertising campaign;
generating a reference ad volume for the inventory unit, based on instructions and the detected ad volume;
generating updated ad delivery control settings for the inventory unit, based on the reference ad volume and the detected ad volume; and
serving an ad impression on the inventory unit based on the updated ad delivery control settings;
wherein the reference ad volume is generated based on a proportion of ad volume served on the inventory unit compared to other inventory units of the online advertising campaign.

20. The computer-readable storage medium of claim 19, wherein the ad delivery control settings include one or more of a bid allocation control signal and a bid price control signal, and one or more of the bid allocation control signal and the bid price control signal are adjusted to achieve a delivery goal defined by the reference ad volume.
